(19) United States
(12) Patent Application Publication
(10) Pub. No.: US 2018/0115111 A1
(43) Pub. Date: Apr. 26, 2018

(54) Connector and Connector Assembly

(71) Applicant: Tyco Electronics (Shanghai) Co. Ltd., Shanghai (CN)

(72) Inventors: Bo Gao, Shanghai (CN); Hao Wang, Shanghai (CN); Biao Pan, Shanghai (CN); Jiefeng Zhang, Shanghai (CN); Ning Wang, Shanghai (CN); Jianfei Yu, Shanghai (CN)

(73) Assignee: Tyco Electronics (Shanghai) Co. Ltd., Shanghai (CN)

(21) Appl. No.: 15/793,074

(22) Filed: Oct. 25, 2017

(30) Foreign Application Priority Data
Oct. 25, 2016 (CN) 201621148187.0

(51) Int. Cl. H01R 13/648; H01R 4/48; H01R 4/30

(52) U.S. Cl. CPC H01R 13/648; H01R 4/30; H01R 4/4863

(57) ABSTRACT

A connector comprises a body, a shield housing fitted over the body, and a spring disposed within the shield housing and fitted over the body. The body has a first positioning structure formed on an outer wall of the body. The shield housing has a second positioning structure formed on an inner wall of the shield housing. The spring has a first end abutting against the second positioning structure and an opposite second end abutting against the first positioning structure.

### CROSS-REFERENCE TO RELATED APPLICATION

This application claims the benefit of the filing date under 35 U.S.C. § 119(a)-(d) of Chinese Patent Application No. 201621148187.0, filed on Oct. 25, 2016.

### FIELD OF THE INVENTION

The present invention relates to a connector and, more particularly, to a connector resistant to vibration.

### BACKGROUND

A cylindrical electrical connector known in the art includes an insulation body, a conductive terminal disposed in the insulation body, and a metal shield housing fitted over the insulation body. The shield housing is commonly formed by stamping a single metal sheet and is substantially rigid.

An external axial impact force acting on the metal shield housing is immediately and directly transferred to the insulation body, causing damage to the insulation body since the insulation body is usually made of plastic with a lower strength. The known cylindrical connector is thus easily damaged when under axial vibration. Furthermore, the known cylindrical connector is not capable of providing effective electromagnetic shielding to a wire connected to the cylindrical connector.

### SUMMARY

A connector according to the invention comprises a body, a shield housing fitted over the body, and a spring disposed within the shield housing and fitted over the body. The body has a first positioning structure formed on an outer wall of the body. The shield housing has a second positioning structure formed on an inner wall of the shield housing. The spring has a first end abutting against the second positioning structure and an opposite second end abutting against the first positioning structure.

### BRIEF DESCRIPTION OF THE DRAWINGS

The invention will now be described by way of example with reference to the accompanying Figures, of which:

FIG. 1 is a perspective view of a connector according to an embodiment;

FIG. 2 is a sectional side view of the connector of FIG. 1;

FIG. 3 is another sectional side view of the connector of FIG. 1;

FIG. 4 is a perspective view of a spring of the connector of FIG. 1;

FIG. 5 is a perspective view of a body of the connector of FIG. 1; and

FIG. 6 is a perspective view of a shield tail cover of the connector of FIG. 1.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

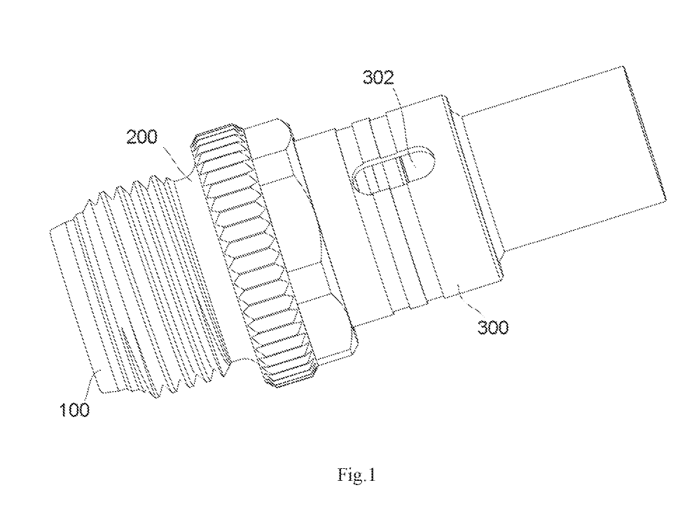

An embodiment of a connector is show in FIGS. 1-3. The connector comprises a body 100, a conductive terminal 120, a shield housing 200, a shield tail cover 300, and a spring 400. The conductive terminal 120 is disposed in the body 100. The shield housing 200 is fitted over the body 100. In an embodiment, the body 100 is formed of an insulative material such as plastic and the shield housing 200 is formed of a metal material. In an embodiment, the connector is a cylindrical connector for use in an instrument, a controlling equipment, or any other type of electrical equipment known to those with ordinary skill in the art.

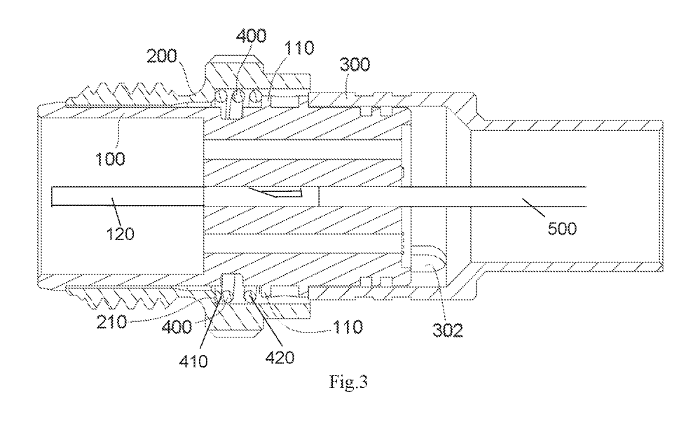

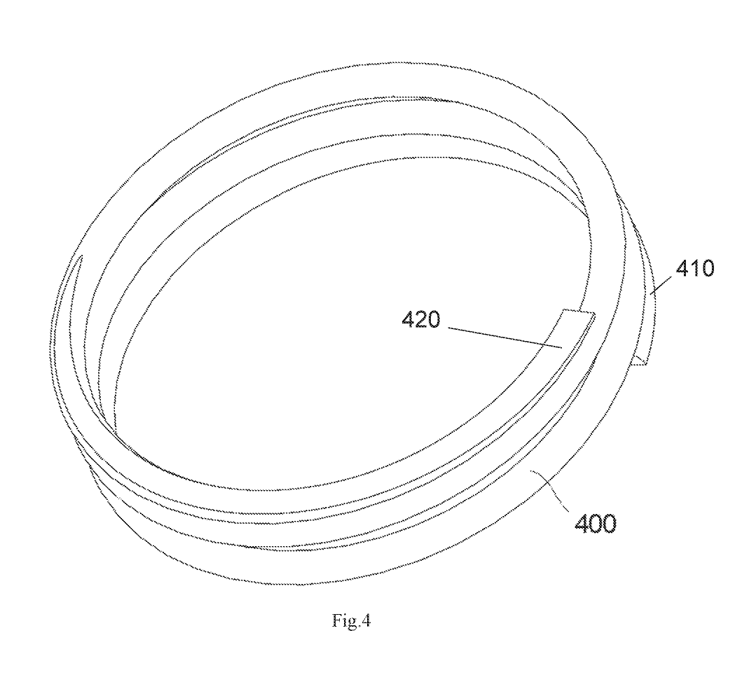

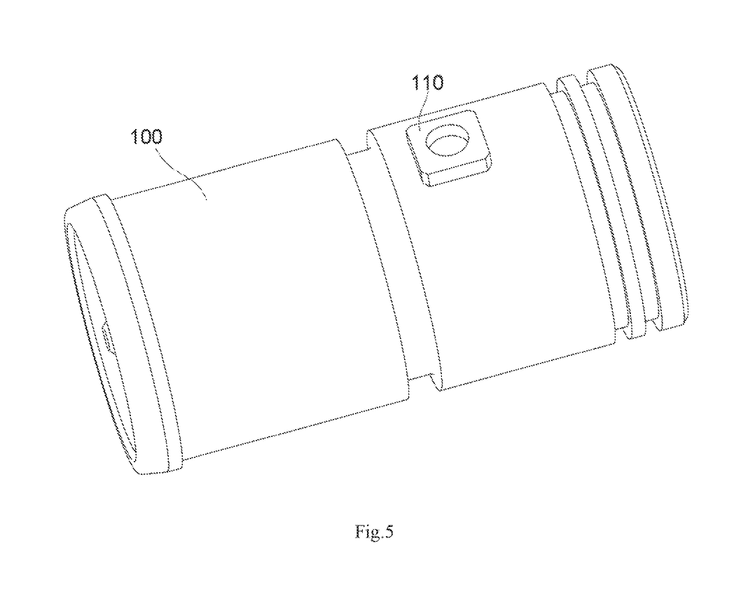

The spring 400, as shown in FIGS. 3 and 4, is fitted over the body 100 and has a first end 410 and an opposite second end 420. The first end 410 of the spring 400 abuts against a first positioning structure formed on an inner wall of the shield housing 200. The second end 420 of the spring 400 abuts against a second positioning structure formed on an outer wall of the body 100. In the embodiment shown in FIGS. 3 and 5, the first positioning structure is a positioning step 210 formed on the inner wall of the shield housing 200 and the second positioning structure is a positioning protrusion 110 formed on an outer wall of the body 100. The spring 400 is positioned between the positioning step 210 and the positioning protrusion 110. The spring 400 is received in the shield housing 200 and is in electrical contact with the shield housing 200.

The spring 400 is capable of absorbing an external axial impact force acting on the shield housing 200, protecting the body 100 from being damaged and improving the anti-vibration performance of the connector. In addition, the spring 400 may also function as an electromagnetic shield, further improving electromagnetic shielding performance of the connector.

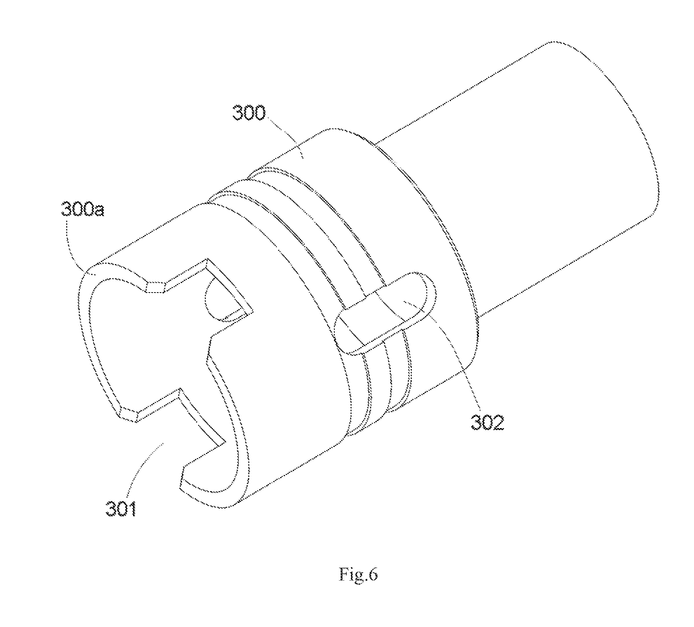

The shield tail cover 300 is shown in FIG. 6. The shield tail cover 300 has a receiving notch 301 disposed at a front end of the shield tail cover 300 having a front end surface 300a. The shield tail cover 300 also has a sealant injection passageway 302 extending through an approximate center of the shield tail cover 300. In an embodiment, the shield tail cover 300 is formed of a metal material.

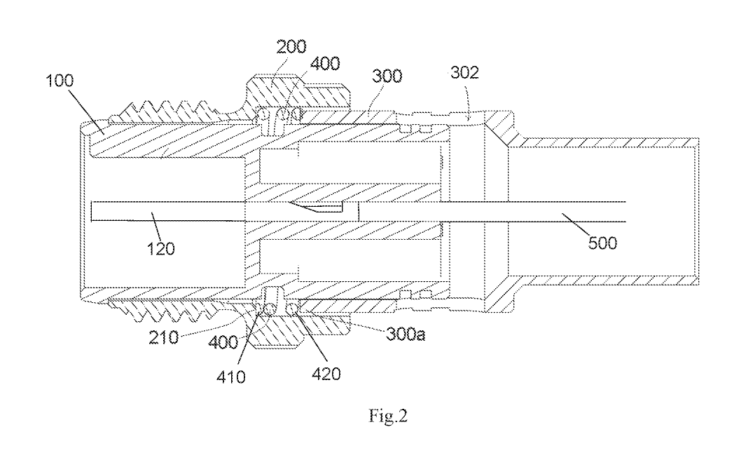

The shield tail cover 300 is fitted over a rear end of the body 100, as shown in FIGS. 2 and 3. The receiving notch 301 is complementary to the positioning protrusion 110, and when the shield tail cover 300 is fitted over the body 100, the positioning protrusion 110 is received in the receiving notch 301. As shown in FIG. 2, when the shield tail cover 300 is fitted over the body 100, the second end 420 of the spring 400 simultaneously abuts against the positioning protrusion 110 of the body 100 and the front end surface 300a of the shield tail cover 300, and the first end 410 of the spring 400 abuts against the positioning step 210 of the shield housing 200. The spring 400 electrically connects the shield tail cover 300 to the shield housing 200.

The shield tail cover 300 is capable of providing electromagnetic shielding for an external wire electrically connected to the connector, thus further improving electromagnetic shielding performance of the connector. Further, the shield tail cover 300 is electrically connected to the shield housing 200 via the spring 400, so that the shield housing 200, the shield tail cover 300 and the spring 400 may function together as an electromagnetic shield, thereby further improving electromagnetic shielding performance of the connector.

A connector assembly according to an embodiment, as shown in FIGS. 2 and 3, comprises the connector and a wire 500 assembled with the connector. One end of the wire 500 passes through the shield tail cover 300 of the connector and is electrically connected to the conductive terminal 120 of the connector. The connector assembly further comprises a sealant injected through the sealant injection passageway 302 into the shield tail cover 300 and bonding the shield tail cover 300 to the body 100 and the wire 500.

In the shown embodiments, the positioning protrusion 110 is formed on the outer wall of the body 100 of the connector. In another embodiment, no positioning protrusion 110 is formed on the outer wall of the body 100 of the connector and the second end 420 of the spring 400 abuts only against the front end surface 300a of the shield tail cover 300.

In the shown embodiments, the shield tail cover 300 is fitted over the rear end of the body 100 of the connector. In another embodiment, the connector may not include the shield tail cover 300 and the second end 420 of the spring 400 abuts only against the positioning protrusion 110 of the body 100.

What is claimed is:

1. A connector, comprising:
a body;
a shield housing fitted over the body and having a first positioning structure formed on an inner wall of the shield housing;
a shield tail cover fitted over a rear end of the body and having a second positioning structure; and
a spring disposed within the shield housing and fitted over the body, the spring having a first end abutting against the first positioning structure and an opposite second end abutting against the second positioning structure.

2. The connector of claim 1, wherein the first positioning structure is a positioning step.

3. The connector of claim 2, wherein the second positioning structure is a front end surface of the shield tail cover.

4. The connector of claim 3, wherein the spring electrically connects the shield tail cover to the shield housing.

5. The connector of claim 1, wherein the body is formed of an insulative material.

6. The connector of claim 5, further comprising a conductive terminal disposed in the body.

7. A connector, comprising:
a body having a first positioning structure formed on an outer wall of the body;
a shield housing fitted over the body and having a second positioning structure formed on an inner wall of the shield housing; and
a spring disposed within the shield housing and fitted over the body, the spring having a first end abutting against the second positioning structure and an opposite second end abutting against the first positioning structure.

8. The connector of claim 7, wherein the first positioning structure is a positioning protrusion.

9. The connector of claim 8, wherein the second positioning structure is a positioning step.

10. The connector of claim 9, further comprising a shield tail cover fitted over a rear end of the body.

11. The connector of claim 10, wherein the shield tail cover has a receiving notch disposed at a front end complementary to the positioning protrusion.

12. The connector of claim 11, wherein the positioning protrusion is received in the receiving notch when the shield tail cover is fitted on the body.

13. The connector of claim 12, wherein the second end of the spring abuts against the positioning protrusion and a front end surface of the shield tail cover.

14. The connector of claim 13, wherein the spring electrically connects the shield tail cover and the shield housing.

15. The connector of claim 10, wherein the shield tail cover has a sealant injection passageway extending through the shield tail cover.

16. The connector of claim 7, wherein the connector is a cylindrical connector.

17. The connector of claim 7, wherein the body is formed of an insulative material.

18. The connector of claim 17, further comprising a conductive terminal disposed in the body.

19. A connector assembly, comprising:
a connector including a body having a first positioning structure formed on an outer wall of the body, a conductive terminal disposed in the body, a shield housing fitted over the body and having a second positioning structure formed on an inner wall of the shield housing, and a spring disposed within the shield housing and fitted over the body, the spring having a first end abutting against the second positioning structure and an opposite second end abutting against the first positioning structure; and
a wire extending through the shield tail cover and electrically connected to the conductive terminal.

20. The connector assembly of claim 19, wherein the shield tail cover has a sealant injection passageway extending through the shield tail cover, a sealant injected through the sealant injection passageway and into the shield tail cover to bond the shield tail cover to the body and the wire.
